(19) United States
(12) Patent Application Publication
(10) Pub. No.: US 2018/0057336 A1
(43) Pub. Date: Mar. 1, 2018

(54) Drink producing apparatus with a dispensing container for liquid, in which a mixing device is disposed, as well as household refrigeration apparatus and method for producing a cooled drink

(71) Applicant: BSH HAUSGERAETE GMBH, MUENCHEN (DE)

(72) Inventors: ANDREAS BABUCKE, HEIDENHEIM (DE); KUDRET BAYSAL, GIENGEN BRENZ (DE); CARSTEN WEISS, GIENGEN (DE)

(21) Appl. No.: 15/252,572

(22) Filed: Aug. 31, 2016

(51) Int. Cl. B67D 1/00; B67D 1/08; F25D 23/12

(52) U.S. Cl. CPC B67D 1/0016; F25D 23/12; B67D 1/0857; B67D 1/0043

(57) ABSTRACT

A drink producing apparatus has a dispensing container, which is formed for receiving a liquid addable to a cooled drink by the drink producing apparatus and which is connected to a dispensing unit of the drink producing apparatus for conducting the liquid from the dispensing container to the dispensing unit, and with a cooling device for cooling the dispensing container, wherein a mixing device for temperature equalizing intermixing of the cooled liquid is disposed in the dispensing container, which has a conveying unit, which has a suction line with a suction opening, which is disposed spaced from a sidewall of the dispensing container and is disposed adjacent to a bottom wall in the dispensing container. The invention also relates to a household refrigeration apparatus and to a method for producing a drink.

### TECHNICAL FIELD

The invention relates to a drink producing apparatus with a dispensing container, which is formed for receiving a liquid addable to a cooled drink by the drink producing apparatus and which is connected to a dispensing unit of the drink producing apparatus for conducting the liquid from the dispensing container to the dispensing unit. The drink producing apparatus moreover includes a cooling device for cooling the dispensing container from the outside. Moreover, the invention also relates to a household refrigeration apparatus with such a drink producing apparatus as well as to a method for producing a cooled drink.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which has a drink apparatus, which is formed for dispensing a drink at this household refrigeration apparatus itself.

Moreover, cold drink machines are also known, in which alcohol containing drinks, for example cocktails, can be dispensed.

In such drink producing apparatuses for producing cooled drinks, tempering is an essential factor. In particular, undesired freezing of a liquid in the drink producing apparatus is to be avoided.

### BRIEF SUMMARY OF THE INVENTION

It is the object of the present invention to provide a drink producing apparatus as well as a household refrigeration apparatus as well as a method for producing a drink, by which or in which the preparation of cooled drinks is improved with regard to avoiding freezing of a liquid addable to the drink.

This object is solved by a drink producing apparatus, a household refrigeration apparatus and a method according to the independent claims.

A drink producing apparatus according to the invention for a household refrigeration apparatus includes at least one dispensing container, which is formed for receiving a liquid addable to a cooled drink by the drink producing apparatus. This dispensing container is connected to a dispensing unit of the drink producing apparatus for conducting this liquid from the dispensing container to the dispensing unit. Moreover, the drink producing apparatus includes a cooling device for cooling the dispensing container, in particular for cooling from the outside. An essential idea of the invention is to be regarded in that a mixing device is disposed in the dispensing container, which is formed for temperature equalizing intermixing of the cooled liquid. The mixing device includes a conveying unit, which has a suction line with a suction opening. The suction opening is disposed spaced from inner sides of sidewalls of the dispensing container, but is disposed adjacent to an inner side of a bottom wall in the dispensing container on the other hand. By such a configuration, a particularly homogeneous and uniform intermixing of the liquid in the dispensing container can be achieved. Thereby, it is avoided that individual and local volume areas are severely cooled such that freezing could occur. Especially if the cooling device surrounds the dispensing container from the outside at least in certain areas, the cooling first preliminary acts on the volume areas in the dispensing container, which directly adjoin to the sidewalls of this dispensing container. Now, in order to avoid freezing of this liquid from the sidewalls towards the interior, the liquid then still warmer in the dispensing container, which is further spaced from the sidewalls, is taken outwards towards the sidewalls such that a warmer liquid is here taken outwards and the cooler liquid located there is then in turn taken away from the sidewalls more centrally in the dispensing container. By this configuration or circulation, a very uniform and preferred intermixing is achieved such that a particularly fast and also homogeneous temperature equalization of the liquid in the dispensing container is effected and this is especially achieved if the cooling device is active and cooling of the dispensing container is effected.

In particular, it is thereby also achieved that a very specific and locally exact transfer of the liquid in the dispensing container into various volume areas is given by the mixing device. Here, an arbitrary intermixing, which would not transfer or only sometimes randomly transfer the desired liquid portions into the respective volume areas, is therefore inhibited.

In particular, it is provided that the mixing device has a distributing device, by which the sucked liquid having been sucked by the conveying unit is taken to the sidewalls and again taken from the distributing device to the suction container adjacent to the sidewalls. By this configuration, the mixing device thus has objective components, which allow specific transfer of the liquid into volume areas adjoining to the sidewalls.

In particular, it is provided that the distributing device has at least one line, which is disposed adjacent to the sidewalls in the dispensing container and which has at least one discharge opening, through which the sucked liquid can again be discharged into the dispensing container near the sidewalls. By this configuration, the local discharge of the liquid into the volume areas near the sides can be transferred even more exactly in position and quantitatively more exactly. The homogeneous temperature equalizing intermixing is thereby again improved.

In particular, it is provided that the line is helically wound circulating around the longitudinal axis of the dispensing container at least in sections and has a plurality of discharge openings. Thereby, the uniform transfer of liquid into the volume areas near the sidewalls of the dispensing container is improved.

It can also be provided that the line is formed meander-like at least in sections viewed in the direction of the longitudinal axis of the dispensing container and is disposed adjacent to a sidewall with this meander section. Thereby too, liquid can thus be taken into these volume areas near the walls in more uniform and extensive manner. Here, a fast and uniform intermixing and thus also temperature equalization is thus allowed.

In particular, it is provided that the drink producing apparatus has at least one further dispensing container, which is formed for receiving a second liquid addable to the cooled drink by the drink producing apparatus. This further dispensing container is connected to the dispensing unit of the drink producing apparatus for conducting the further or second liquid from the further dispensing container to the dispensing unit.

In particular, the two liquids have different freezing points. It can be provided that one liquid is water or contains water and the further liquid is alcohol or contains alcohol.

Furthermore, the invention also relates to a household refrigeration apparatus for storing and preserving food, which can for example be a refrigerator or a freezer or a combined refrigerator-freezer. The household refrigeration apparatus includes a housing, in which a receiving space for food is formed. The household refrigeration apparatus moreover includes a drink producing apparatus according to the invention or an advantageous configuration thereof.

Furthermore, the invention also includes a method for producing a cooled drink by a drink producing apparatus, which is equipped with a dispensing container formed for receiving a liquid addable to the cooled drink by the drink producing apparatus. The dispensing container is connected to a dispensing unit of the drink producing apparatus for conducting the liquid from the dispensing container to the dispensing unit. The dispensing container is in particular cooled from the outside by a cooling device. An essential idea is to be regarded in that the liquid in the dispensing container is intermixed by a mixing device of the drink producing apparatus disposed in the dispensing container in temperature equalizing manner and thereto liquid is specifically received from a volume area formed spaced from the sidewalls of the dispensing container and taken into volume areas adjoining to the sidewalls in the dispensing container by the mixing device. The circulation of the liquid already introduced in the dispensing container in the dispensing container itself prevents freezing of the liquid in volume areas near the sidewalls of the dispensing container.

In particular, the liquid in the dispensing container is sucked near the bottom and centrally viewed in a horizontal plane of the dispensing container and conveyed off-center towards the sidewalls in the dispensing container by a distributing device, wherein the liquid is conducted again from the distributing device into the dispensing container adjacent to the sidewalls.

Advantageous implementations of the drink producing apparatus according to the invention are to be regarded as advantageous implementations of the method according to the invention, wherein the respective objective features of the drink producing apparatus are thereto formed for performing the method steps.

In addition, it can also be provided that the drink producing apparatus is formed for receiving a capsule, in which additives or addition media are contained, which can be added to the drink. The additives can be powdery or gelatinous or also liquid. The capsule can be inserted into a dispensing area of the drink producing apparatus and this ingredient of the capsule can then also be automatically dispensed or added upon dispensing the drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible and exposed on the front side and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing drinks can be simplified. An essential advantage of this configuration is to be regarded in that the accessibility to the housing of the drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention; and

FIG. 2 a schematic representation of components of an embodiment of a drink producing apparatus.

### PREFERRED IMPLEMENTATIONS OF THE INVENTION

In the figures, identical or functionally identical elements are provided with the same reference characters.

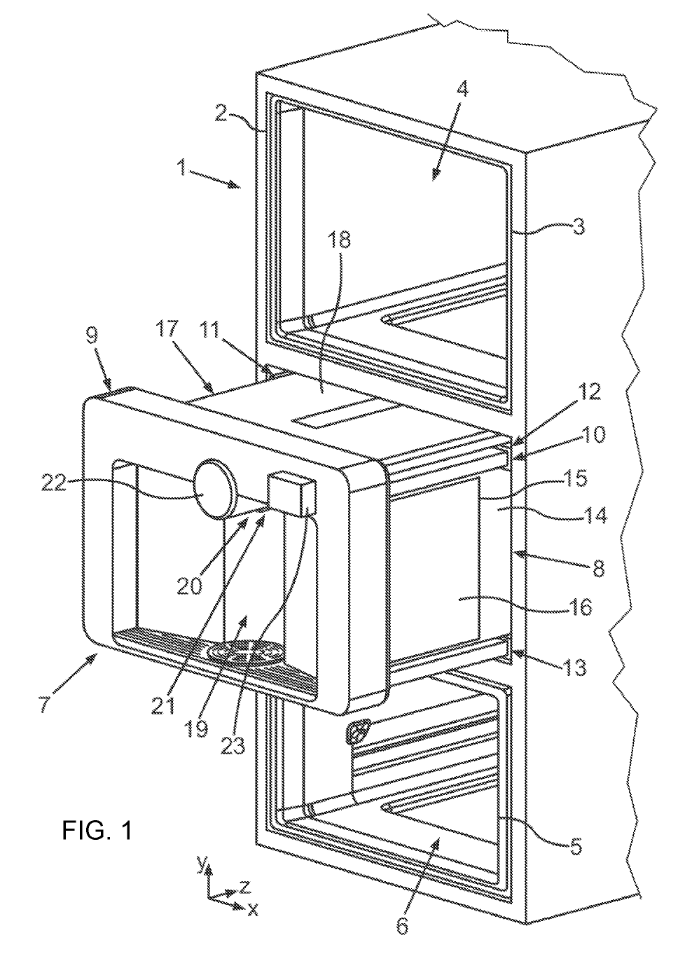

In FIG. 1, a household refrigeration apparatus 1 is illustrated in a partial area in a simplified perspective representation. Here, the household refrigeration apparatus 1 is for example a combined refrigerator-freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7.

However, the drink producing apparatus 7 can also be formed as a separate independent apparatus and thus be installed independently of a household refrigeration apparatus 1 and operable independently thereof.

The drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 has a housing 9.

In the embodiment, it is provided that the housing 9 and thus the entire drink producing apparatus 7 can be extracted from and again retracted into the receiving area 8 in depth direction and thus in horizontal direction corresponding to the z-direction corresponding to a drawer. In FIG. 1, the completely extracted state is shown.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also has an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 has a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead of it, a magnetic mount can also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead of it, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can be admixed to this drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the drink, this ingredient or additive is then removed from the capsule and added to the drink in particular before or after dispensing into the drinking vessel effected via the dispensing opening 21.

Moreover, it can in particular be provided that the drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 has a cartridge for admixing carbon dioxide into the drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the drink as water does not have to be stored in a largely dimensioned container in the drink producing apparatus 7 but that this container can then be smaller dimensioned and can be refilled depending on demand and adapted to situation. It can then also be provided that such a water supply for producing the drink is not supplied from the tank or the container provided for receiving this liquid in the drink producing apparatus 7, but additionally or instead thereof can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the drink should then be desired, thus, this can be allowed via admixture of carbonized cold water, which is cooled in the drink producing apparatus 7, or via a carbonized second liquid, which is then present in the second container.

It is in particular provided that the drink producing apparatus 7 has a first container, in which a first liquid with a first freezing point, in particular water, is then provided or stored to then provide it for producing and dispensing a drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the drink can also be an alcoholized drink.

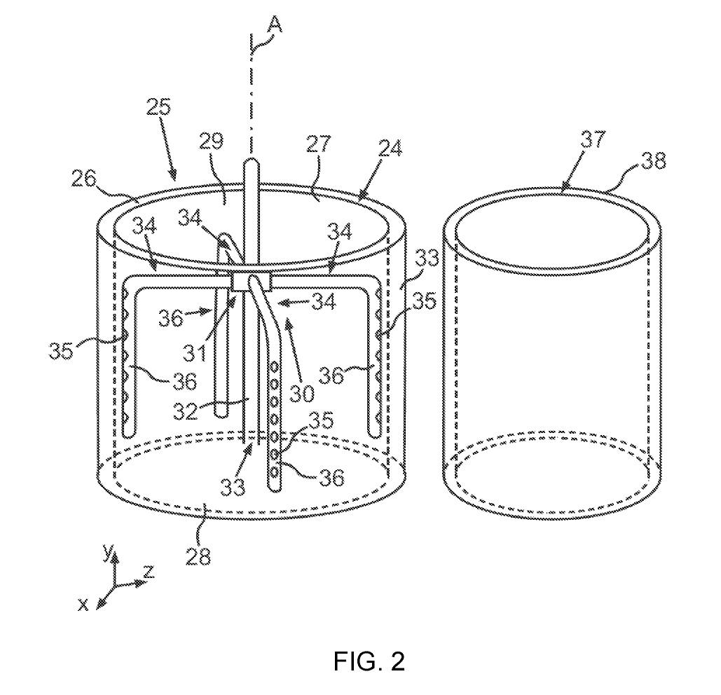

In FIG. 2, a container or dispensing container 24 of the drink producing apparatus 7 is shown in a simplified schematic representation. This dispensing container 24 is formed for receiving a liquid, which can be added to the drink, which is dispensed via the dispensing opening 21. In particular, the drink producing apparatus 7 has a second dispensing container 37, in which a second liquid different from the first liquid is present. For producing the drink, the two liquids can then be mixed. The two liquids can in particular be water and alcohol and a water containing liquid and an alcohol containing liquid, respectively.

In particular, it is provided that the at least one dispensing container 24 can be cooled by a cooling device 25. The cooling device 25 is in particular a component of the drink producing apparatus 7. The cooling device 25 can for example be a refrigeration circuit, which has a condenser, a compressor and an evaporator 26. The evaporator 26 is disposed outside of the dispensing container 24 and thermally coupled to it. Therefore, it cools the dispensing container 24 from the outside and preferably abuts on the outer sides thereof. The further dispensing container 37 can also be cooled from the outside by a further, separate evaporator 38.

In the shown implementation, the dispensing container 24 is cylindrical, wherein the shaping is to be understood only exemplarily and is not conclusive at all. In this context, the dispensing container 24 includes a jacket wall or a sidewall 27 as well as a bottom wall 28 and a ceiling wall 29. Moreover, the drink producing apparatus 7 includes a mixing device 30, which is formed for temperature equalizing intermixing of the liquid in the dispensing container 24. The mixing device 30 is disposed in the dispensing container 24 itself at least in certain areas. This mixing device 30 includes a conveying unit 31, which has a suction line 32. The suction line 32 is disposed very close to, but slightly spaced from the bottom wall 28 and thus from an inner side of the bottom wall 28 with a suction opening 33. Moreover, it is disposed centrally in a horizontal plane spanned by the x-z plane or substantially centrally with respect to the dimensions of the dispensing container 24 and thus the bottom wall 28. Moreover, the mixing device 30 includes a distributing device 34, which can be most diversely configured. In FIG. 2, only for exemplary illustration of the operation of the distributing device 34, it is illustrated with multiple lines 36, which can exemplarily be distributing branches, which lead away from the conveying unit 31. The distributing device 34 allows taking the sucked liquid from the center or from the central volume area of the suction container 24 to volume areas located further outwards in locally specific and defined manner. Thus, transfer of this centrally sucked liquid into volume areas adjoining to the inner sides of the sidewall 27 is allowed. By such a configuration, very homogeneous intermixing is thus achieved, which can also be very fast and extensively effected. in this context, it is then also avoided that undesired or early freezing of the liquid in the volume areas adjoining to the sidewall 27 occurs due to the local effect of the means to be cooled, in particular of the evaporator 26.

As is apparent here, the lines 36 also extend at least in certain areas, in particular over at least 50 percent of the height (y-direction) of the dispensing container 24 and the sections of the lines 36 oriented in this height direction in this respect preferably have multiple discharge openings 35. For the sake of clarity, only some of these discharge openings 35 are provided with the corresponding reference characters. By this local position and the dimensioning of the discharge openings 35, a very uniform distribution of the sucked liquid into the volume area near the sidewall of the suction container 24 is allowed.

Diverse other configurations of the distributing device 34 can also be provided. Here, only one line 36 can for example also be provided, which for example helically circulates around a longitudinal axis A of the dispensing container 24 and also has corresponding discharge openings 35. It can also be provided that a distributing device is formed meander-like viewed in the direction of this longitudinal axis A at least in sections. These are only exemplary indications of geometries of the possible lines of distributing devices and/or exemplary numbers of distributing devices, which can diversely vary. It is essential that the mixing device 30 is formed such that specific conveyance of substantially centrally sucked liquid towards the sidewalls 27 can be effected and there again be discharged near the sidewalls. In the configuration of a cylindrical realization of the dispensing container 24 shown here, only one sidewall 27 is present since it presents the jacket wall. If the dispensing container 24 is formed with another cornered geometry, for example prismatic or the like, multiple such sidewalls are present. The position, number and shaping of the L-like branches exemplarily explained in FIG. 2 as lines 36 of the distributing device 34 are therefore also to be regarded as to be understood in non-conclusive manner.

### LIST OF REFERENCE CHARACTERS

1 Household refrigeration apparatus
2 housing
3 interior container
4 first receiving space
5 interior container
6 second receiving space
7 drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 dispensing container
25 cooling device
26 evaporator
27 sidewall
28 bottom wall
29 ceiling wall
30 mixing device
31 conveying unit
32 suction line
33 suction opening
34 distributing device
35 discharge opening
36 line
37 dispensing container
38 evaporator
A longitudinal axis

1. A drink producing apparatus, comprising:
a dispensing unit for dispensing liquid from the drink producing apparatus,
a dispensing container, which is formed for receiving a liquid addable to a cooled drink by the drink producing apparatus and has a sidewall and a bottom wall, and
the dispensing container is connected to a dispensing unit for conducting the liquid from the dispensing container to the dispensing unit, and
a cooling device for cooling the dispensing container,
a mixing device, which is disposed in the dispensing container and is formed for temperature equalizing intermixing of the cooled liquid,
the mixing device has a conveying unit, which
has a suction line with a suction opening, which is disposed spaced from the sidewall of the dispensing container and adjacent to the bottom wall in the dispensing container.

2. The drink producing apparatus according to claim 1, wherein the mixing device has a distributing device, by which the sucked liquid can be taken to the sidewall and can again be discharged from the distributing device into the dispensing container adjacent to the sidewall.

3. The drink producing apparatus according to claim 2, wherein the distributing device has at least one line, which is disposed adjacent to the sidewall in the dispensing container at least in sections and which has at least one discharge opening, through which the sucked liquid can again be discharged into the dispensing container near the sidewall.

4. The drink producing apparatus according to claim 3, wherein the line is helically wound circulating around a longitudinal axis of the dispensing container at least in sections and has a plurality of discharge openings and/or has L-like branches at least in sections.

5. The drink producing apparatus according to claim 3, wherein the line is formed meander-like at least in sections viewed in the direction of a longitudinal axis ( ) of the dispensing container and is disposed immediately adjacent to the sidewall with this meander section.

6. The drink producing apparatus according to claim 1, wherein
the drink producing apparatus has at least one further dispensing container, which is formed for receiving a second liquid addable to the cooled drink by the drink producing apparatus and which is connected to the dispensing unit of the drink producing apparatus for conducting the second liquid from the further dispensing container to the dispensing unit.

7. The drink producing apparatus according to claim 6, wherein the two liquids have different freezing points.

8. A household refrigeration apparatus with a housing, in which a receiving space for food is formed, and with a drink producing apparatus having:
a dispensing unit for dispensing liquid from the drink producing apparatus,
a dispensing container, which is formed for receiving a liquid addable to a cooled drink by the drink producing apparatus and has a sidewall and a bottom wall, and
the dispensing container is connected to a dispensing unit for conducting the liquid from the dispensing container to the dispensing unit, and
a cooling device for cooling the dispensing container,
a mixing device, which is disposed in the dispensing container and formed for temperature equalizing intermixing of the cooled liquid,
the mixing device has a conveying unit, which
has a suction line with a suction opening, which is disposed spaced from the sidewall of the dispensing container and adjacent to the bottom wall in the dispensing container.

9. A method for producing a cooled drink by a drink producing apparatus having the following steps of:
providing a dispensing unit for dispensing liquid from the drink producing apparatus,
providing a dispensing container, which is formed for receiving a first liquid addable to a drink by the drink producing apparatus,
connecting the dispensing container to the first dispensing unit for conducting the liquid from the dispensing container to the dispensing unit,
cooling the dispensing container by a cooling device of the drink producing apparatus
temperature equalizing intermixing of the liquid by a mixing device of the drink producing apparatus disposed in the dispensing container, wherein and thereto
liquid is locally specifically received from a volume area of the dispensing container spaced from a sidewall of the dispensing container and transferred into volume areas adjoining to the sidewall by a conveying unit of the mixing device.

10. The method according to claim 9, wherein liquid in the dispensing container is sucked near the bottom and centrally viewed in horizontal plane of the dispensing container and conveyed off-center towards the sidewall by a distributing device, wherein the liquid is again conducted from the distributing device into the dispensing container adjacent to the sidewall.
